(19) United States
(12) Patent Application Publication
(10) Pub. No.: US 2015/0222527 A1
(43) Pub. Date: Aug. 6, 2015

(54) METHOD AND SYSTEM FOR IMPLEMENTING A PRIORITY FOR ACCESS POINTS

(71) Applicant: ARUBA NETWORKS INC., SUNNYVALE, CA (US)

(72) Inventors: Varun Shah, Sunnyvale, CA (US); Manoj Gupta, Santa Clara, CA (US); Santashil PalChaudhuri, West Bengal (IN)

(73) Assignee: ARUBA NETWORKS INC., Sunnyvale, CA (US)

(21) Appl. No.: 14/170,529

(22) Filed: Jan. 31, 2014

(51) Int. Cl. H04L 12/725; H04L 12/853; H04L 12/801; H04W 48/20

(52) U.S. Cl. CPC H04L 45/3065; H04W 48/20; H04L 47/2416; H04L 47/14

(57) ABSTRACT

A non-transitory computer readable medium includes instructions which, when executed by one or more hardware processors, cause performance of operations including determining a priority level for an Access Point (AP). Subsequent to determining the priority level for the AP, the instructions further cause performance of operations including receiving multiple packets, determining one or more transmission parameters for transmitting the packets based at least in part on the priority level of the AP, and transmitting the packets using the one or more transmission parameters that were determined based at least in part on the priority level of the AP.

### CROSS-REFERENCE TO RELATED APPLICATIONS

This application is related to U.S. patent application Ser. No. 13/931,629. U.S. patent application Ser. No. 13/931,629 is incorporated herein by reference in its entirety.

### BACKGROUND

Over the past decade, there has been a substantial increase in the use and deployment of wireless devices, from dual-mode smartphones to tablet devices. With “wireless” becoming the de-facto medium for network connectivity among users, it has become increasingly important for certain wireless devices, such as Access Points (APs) to prioritize the transmissions for certain data.

In general, data is associated with different priority levels. For example, voice data may be associated with a higher priority level than background data. The reliability and/or the throughput of voice data packets is important to ensure that a user using a receiving device is able to understand the voice message.

Conventionally, access points are configured to receive data with a corresponding priority level of the data and select transmission parameters for transmitting the data based on the priority level received with the data.

### Overview

In general, in one aspect, embodiments relate to a non-transitory computer readable medium including instructions which, when executed by one or more hardware processors, cause performance of operations including determining a priority level for an Access Point (AP). Subsequent to determining the priority level for the AP, the instructions further cause performance of operations including receiving multiple packets, determining one or more transmission parameters for transmitting the packets based at least in part on the priority level of the AP, and transmitting the packets using the one or more transmission parameters that were determined based at least in part on the priority level of the AP.

In general, in one aspect, embodiments relate to a system including at least one device including a hardware processor. The system is configured to perform operations including determining a priority level for an access point (AP). Subsequent to determining the priority level for the AP, the system is configured to further perform operations including receiving multiple packets, determining one or more transmission parameters for transmitting the packets based at least in part on the priority level of the AP, and transmitting the packets using the one or more transmission parameters that were determined based at least in part on the priority level of the AP.

In general, in one aspect, embodiments relate to a method including determining a priority level for an access point (AP). Subsequent to determining the priority level for the AP, the method further includes receiving multiple packets, determining one or more transmission parameters for transmitting the packets based at least in part on the priority level of the AP, and transmitting the packets using the one or more transmission parameters that were determined based at least in part on the priority level of the AP.

Other aspects will be apparent from the following description and the appended claims.

### BRIEF DESCRIPTION OF DRAWINGS

FIGS. 1, 2, 3A, and 3B show schematic diagrams of a system in accordance with one or more embodiments.

FIGS. 4A, 4B, and 5 show flowcharts in accordance with one or more embodiments.

FIG. 6 shows an example in accordance with one or more embodiments.

### DETAILED DESCRIPTION

Specific embodiments will now be described in detail with reference to the accompanying figures. Like elements in the various figures are denoted by like reference numerals for consistency. In the figures, three co-linear dots indicate that additional items of similar type to the preceding and succeeding items with respect to the dots may optionally exist.

In general, embodiments provide a method, system, and computer readable medium for prioritizing Access Points (APs). Specifically, one or more embodiments calculate the priority of an access point (AP) and determine packet transmission parameters based on at least the priority of the AP. In one or more embodiments, the priority of the AP to be used for determining the transmission parameters for transmitting a currently queued packet may be based on properties of the AP, the properties of packets previously transmitted by the AP, other factors, or a combination thereof. The packet transmission parameters define when and/or how packets are transmitted from the AP in accordance with one or more embodiments.

In the following description, several specific details are presented to provide a thorough understanding of the invention. The context of the disclosure is directed to state synchronization among surrounding network devices (e.g. APs “APs”) through any one of a plurality of distribution schemes, including wireless (over-the-air) distribution, multicast distribution and/or wired distribution. Whichever distribution scheme is utilized for state synchronization, the network devices now are configured to operate collectively so that the functionality of the wireless network may be optimized through adjustments to its operation and/or capabilities (hereinafter generally referred to as “functionality”) of one or more network devices. One skilled in the relevant art may recognize, however, that the concepts and techniques disclosed herein can be practiced without certain details such as the inclusion or exclusion of one or more operations, various logic, or the like.

Herein, certain terminology is used to describe features within embodiments of the invention. For example, the term “network device” generally refers to electronic equipment configured to communicate over a network and/or process information related to such communications. Different categories of network devices may include, but are not limited to (1) a client device being any consumer electronics with wireless network connectivity (e.g., tablet; laptop; desktop; netbook; television; set-top box; video gaming control; mobile handset with cellular and/or wireless connectivity such as a smartphone, personal digital assistant “PDA”; etc.); (2) an AP; (3) a data control device (e.g., network switch, controller, etc.); (4) a multicast router; or the like. The network device may be adapted with circuitry to support wireless connectivity with other network devices being part of a wireless network.

It is contemplated that a network device includes hardware logic such as one or more of the following: (i) processing circuitry; (ii) one or more communication interfaces such as a radio (e.g., component that handles the wireless data transmission/reception) and/or a physical connector to support wired connectivity; and/or (iii) a data store in the form of a non-transitory computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; etc.) or any connector for receiving a portable memory device such as a Universal Serial Bus “USB” flash drive, portable hard disk drive, or the like.

Herein, the term “logic” is generally defined as hardware and/or software. For example, as hardware, logic may include processing circuitry (e.g., a microcontroller, any type of processor, a programmable gate array, an application specific integrated circuit, etc.), semiconductor memory, combinatorial logic, or the like. As software, logic may be one or more software modules, such as executable code in the form of an executable application, an application programming interface (API), a subroutine, a function, a procedure, an object method/implementation, an applet, a servlet, a routine, a source code, an object code, a shared library/dynamic load library, or one or more instructions. These software modules may be stored in any type of a suitable non-transitory storage medium (described above) or transitory computer-readable transmission media (e.g., electrical, optical, acoustical or other form of propagated signals such as carrier waves, infrared signals, digital signals).

The term “interconnect” is broadly defined as a logical or physical communication path such as, for instance, electrical wire, optical fiber, cable, bus trace, or a wireless channel using infrared, radio frequency (RF), or any other wireless signaling mechanism. The term “message” constitutes a grouping of data, which may be placed in the form of a packet, a stream (e.g., a sequence of packets), a frame, an Asynchronous Transfer Mode (ATM) cell, or any other series of bits having a prescribed format.

Lastly, the terms “or” and “and/or” as used herein are to be interpreted as an inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Certain details are set forth below in order to provide a thorough understanding of various embodiments of the disclosure, albeit the invention may be practiced through many embodiments other that those illustrated. Well-known logic and operations may not be set forth in detail in order to avoid unnecessarily obscuring this description. Moreover, the illustrated embodiments of the disclosure, and the description associated therewith, should be considered as examples of the principles of the invention and not intended to limit the disclosure to those specific embodiments. It should be understood that this disclosure covers all modifications, equivalents, and alternatives falling within the spirit and scope of the present disclosure.

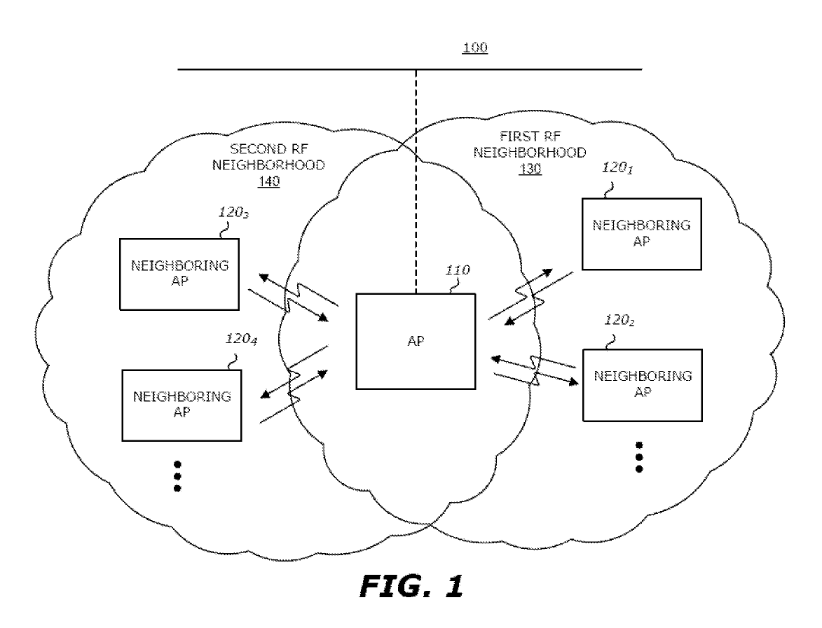

Referring to FIG. 1, a general block diagram of a first network device (110) (e.g. AP “AP”) and one or more other network device (120₁-120ₘ) (e.g., neighboring AP(s)) communicatively coupled together via a network 100 is shown. AP (110) and neighboring AP(s) (120₁-120ₘ) (M>1, M=4 as shown) exchange state information in accordance with a synchronized distribution scheme, where the state information from any one of these APs (110) and (120₁-120₄) may cause another one of the APs to reduce its functionality. In the alternative or in combination with other uses, the state information may be used to control access by one or more client devices (not shown) to the network (100).

According to this embodiment of the disclosure, network (100) is a wireless local area network (WLAN) operating in compliance with the Institute of Electrical and Electronic Engineers (IEEE) 802.11 Standard entitled “Part 11: Wireless LAN Medium Access Control (MAC) and Physical Layer (PHY) specifications,” Mar. 29, 2012. However, it is contemplated that network (100) may support any of a number of other wireless communication schemes including HiperLan/1, HiperLan/2, IEEE 802.16 Standard, or the like.

As illustrated, the infrastructure of network (100) is a collection of network devices that is adapted to support communications between client devices and resources on the network (100). As illustrated, AP (110) is configured to provide and maintain network connectivity over a first wireless channel (referred to as its “home channel”) with one or more client devices that are associated to and authenticated by AP (110). However, at different prescribed times, AP (110) is configured in monitor-mode to scan one or more other wireless channels (referred to as its “foreign channels”) to acquire state information from neighboring (APs 120₁-120₄). During a scan session, AP (110) may scan one of its foreign channels, where this channel constitutes a home channel for one or more of the neighboring APs (120₁-120₄).

More specifically, according to one embodiment of the disclosure, AP (110) is configured to scan, at a first prescribed time interval, for wireless communications over a second wireless channel. One purpose for such scanning is to obtain state information from other wireless network devices, such as neighboring APs (120₁) and (120₂) for example, which are operating on the second wireless channel being their home channel and are residing within a first (one-hop) radio frequency (RF) neighborhood (130). The first RF neighborhood (130) is defined by a first radio frequency (RF) communication range from AP (110). Of course, state information may be obtained for network devices operating outside the first RF neighborhood (130), such as a remote AP within an N-hop RF neighborhood (N>2), by one of the neighboring APs (e.g., neighboring AP 120₁) obtaining state information from the remote AP and subsequently distributing such state information to AP (110).

As further shown in FIG. 1, AP (110) is configured to scan, at a second prescribed time interval different than the first prescribed time interval, for wireless communications over a third wireless channel within a second RF neighborhood (140). The third wireless channel is different, and normally non-interfering, from the second wireless channel. Defined by a second RF communication range from AP (110), the second RF neighborhood (140) comprises neighboring AP (120₃) and (120₄).

It is contemplated that the distribution of state information between AP (110) and neighboring APs (120₁-120₄) is accomplished during different scan sessions. These scan sessions may be performed by active scanning a particular (wireless) foreign channel, where AP (110) transmits a message (e.g. PROBE REQUEST message), as a broadcast or unicast transmission, and subsequently monitors that particular foreign channel for one or more messages in response to the transmitted message (e.g. PROBE RESPONSE messages). Alternatively or in combination with active scanning, passive scanning of the particular foreign channel may be conducted, where AP (110) detects a message transmitted over the particular wireless channel (e.g., a BEACON message) and stores information associated with that message.

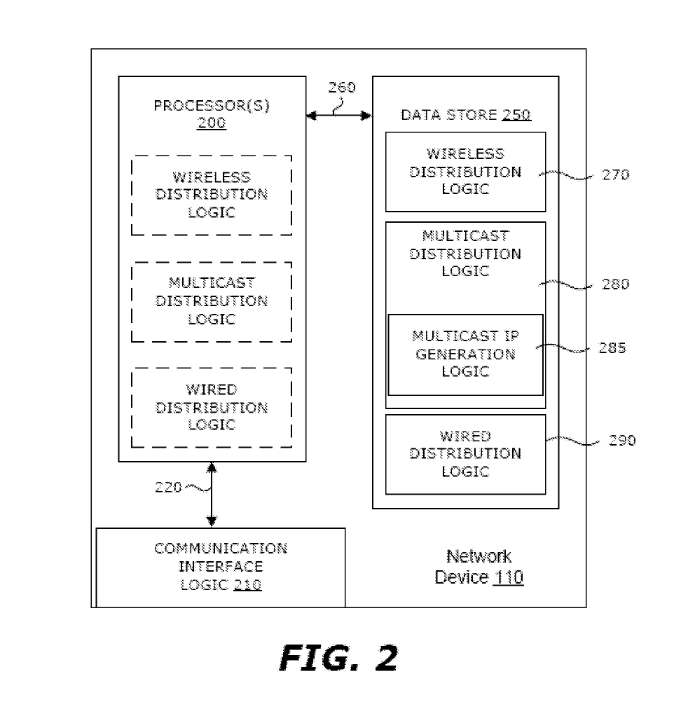

Referring now to FIG. 2, an exemplary block diagram of logic implemented within a network device (e.g., AP 110) of FIG. 1 that exchanges synchronization state information with neighboring network devices (e.g., neighboring APs (120₁-120₄)) is shown. Herein, AP (110) comprises one or more hardware processors (200) that are coupled to communication interface logic (210) via a first interconnect (220). According to one embodiment of the disclosure, communication interface logic (210) may be implemented as a physical interface such as an IEEE 802.3 Ethernet interface and/or one or more radio units (e.g., hardware transceiver, transmitter/receiver, etc.) for supporting wireless communications with other wireless network devices.

Processor (200) is further coupled to a data store (250) via a second interconnect (260). According to one embodiment of the disclosure, data store (250) is persistent memory that is adapted to store wireless distribution logic (270), multicast distribution logic (280) and wired distribution logic (290). As shown, logic (270), (280) and/or (290) comprise software modules executed by processor(s) (200) to control distribution of state information between AP (110) and other neighboring APs (120₁-120ₘ) illustrated in FIG. 1. However, it is contemplated that one or more of logic (270), (280) and/or (290) may be implemented as either circuitry within processor(s) (200) (represented by dashed lines) or other circuitry within AP (110) (not shown).

In general, wireless distribution logic (270) is configured to conduct active scanning of predetermined wireless channels to exchange state information with neighboring APs, where such scanning may be conducted through a series of messages, such as an exchange of data messages or management messages such as PROBE REQUEST and PROBE RESPONSE messages.

More specifically, according to one embodiment of the disclosure, AP (110) has access to network resources to obtain information directed to what wireless channels are identified as “home channels” for the neighboring APs and are different from its home channel. During every scan session on a selected foreign channel (home channel for the neighboring AP), AP (110) sends a PROBE REQUEST message that includes an information element containing the state information for AP (110). Hence, the neighboring APs (e.g., neighboring APs (120₁ and 120₂)) operating on this channel receive the state information.

In response to receiving the PROBE REQUEST message, neighboring AP (120₁) sends a PROBE RESPONSE message that includes an information element, which contains state information for that neighboring AP (120₁). The PROBE RESPONSE message is received by AP (110). Similarly, neighboring AP (120₂) also sends a PROBE RESPONSE message containing state information for neighboring AP (120₂) in response to receiving the PROBE REQUEST message. The PROBE RESPONSE message is received by AP. Hence, during one scan interval, AP (110) and its neighboring APs (120₁) and (120₂) listening on that particular wireless channel will share their state information with each other.

If the neighboring APs do not belong to the same subnet, then a broadcast transmission will be unsuccessful. Instead, unicast messages will need to be sent from AP (110) to neighboring APs (120₁-120ₘ).

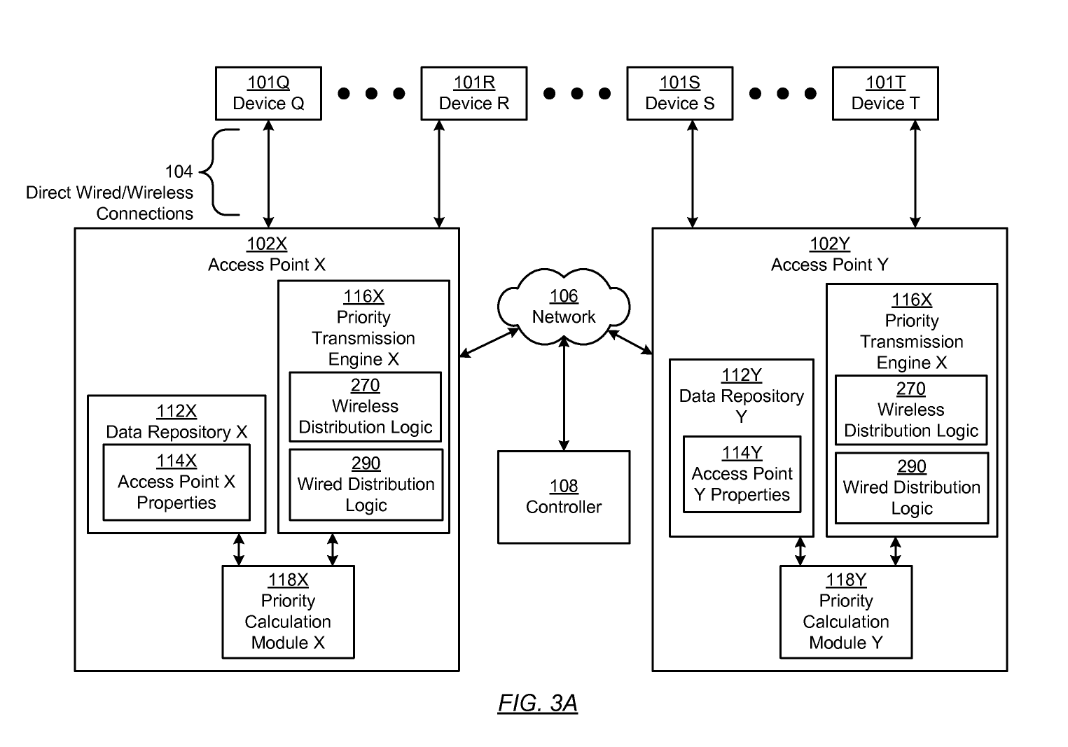

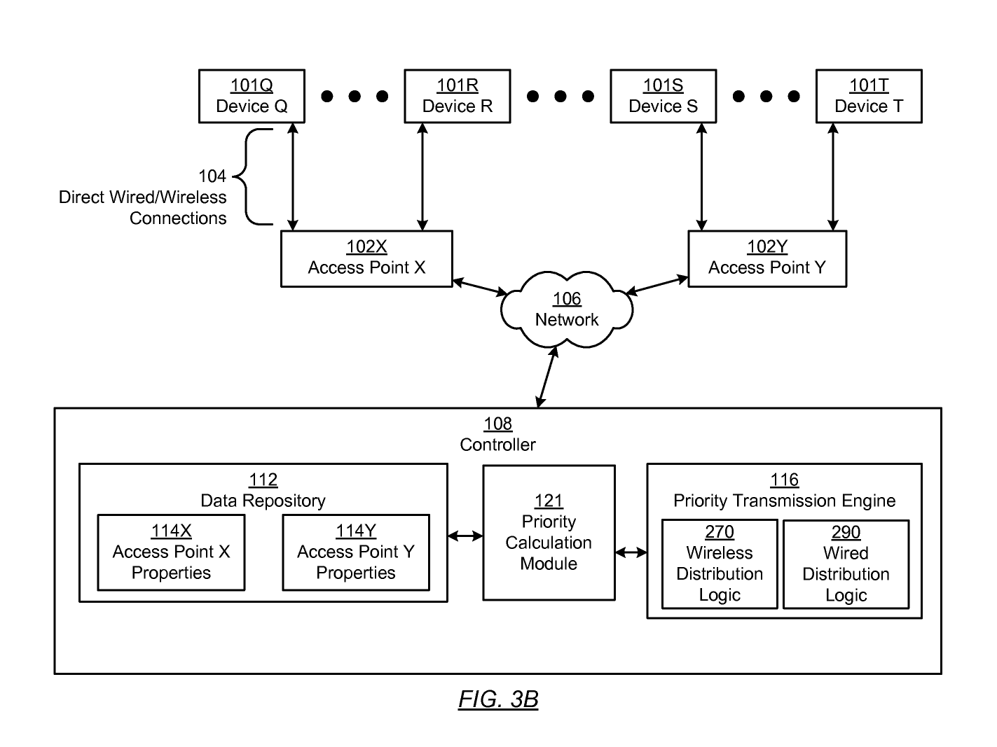

FIG. 3A shows a schematic diagram of a system in accordance with one or more embodiments. As shown in FIG. 3A, the system includes devices (e.g., device Q (101Q), device R (101R), device S (101S), device T (101T)), APs (e.g., AP X (102X), AP Y (102Y)), a network (106), and a controller (108). Each of these components is discussed below in accordance with one or more embodiments.

In one or more embodiments, a device (e.g., device Q (101Q), device R (101R), device S (101S), device T (101T)) is a hardware component that receives a service from another device of the system and/or provides a service to another device of the system. Specifically, when the device receives a service, the device may be referred to as a client device with respect to the service. When a device provides a service, the device may be referred to as a resource with respect to the service.

In one or more embodiments, a device (e.g., device Q (101Q), device R (101R), device S (101S), device T (101T)) may be one or more mobile devices (e.g., laptop computer, smart phone, personal digital assistant, tablet computer, or other mobile device), gaming console, desktop computers, servers, blades in a server chassis, or any other type of electronic device or devices that includes at least the minimum processing power, memory, and input and output device(s) to perform one or more embodiments. For example, the device may include one or more hardware processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The hardware processor(s) may be an integrated circuit for processing instructions. For example, the hardware processor(s) may be one or more cores, or micro-cores of a processor. The device may also include one or more input device(s), such as a touchscreen, keyboard, mouse, microphone, touchpad, electronic pen, or any other type of input device. Further, the device may include one or more output device(s), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The input and output device(s) may be locally or remotely (e.g., via the network) connected to the hardware processor(s), memory, and storage device(s). Many different types of devices exist, and the aforementioned input and output device(s) may take other forms.

The device may be connected to a network (106) via a network interface connection (not shown) and an AP (e.g., AP X (102X), AP Y (102Y)). The network (106) may be a local area network (LAN), a wide area network (WAN) such as the Internet, mobile network, or any other type of network, or a combination of networks. The network (106) in FIG. 3A may the same or similar to the network (100) as described in FIG. 1.

An AP (e.g., AP X (102X), AP Y (102Y)) is a digital hardware device that may be communicatively coupled to the network (106). The AP (e.g., AP X (102X), AP Y (102Y)) is a separate hardware unit from a device (e.g., device Q (101Q), device R (101R), device S (101S), device T (101T)), that is directly, wired or wirelessly, connected to the device and is in a communication path from the device to the network. In other words, the AP may be directly connected via the direct wired/wireless connection (104) to a network interface card on the device (e.g., device Q (101Q), device R (101R), device S (101S), device T (101T)). The APs include functionality to transmit and receive packets (discussed below) via the network (106) and wired/wireless connection (104). Further, APs may be directly connected to the network (106) or connected via a controller. By way of an example, the AP may include a wireless AP (WAP) that communicates wirelessly with devices using Wi-Fi, Bluetooth or related standards and that communicates with a wired network. An AP (e.g., AP X (102X), AP Y (102Y)) also includes the functionality of the APs (e.g., neighboring APs (120₁, 120₂, 120₃, and 120₄)) described in FIG. 1.

Each AP may be connected to any number of devices at any moment in time. Specifically, each AP may be connected to no devices, a single device, or multiple devices at any particular moment in time. Further, the number of devices connected to an AP may be heterogeneous amongst APs.

Each AP is configured to transmit packets (not shown) for devices connected to the APs. In one or more embodiments, a packet is formatted data that may be sent between APs, devices, or a combination thereof. A packet includes a packet payload and a packet header. The packet payload is the data to be transmitted. For example, the packet payload may include video data, voice data, a message, or other information. The packet header includes packet properties. A packet property is any control information for a packet. In one or more embodiments, a packet property includes the type of data carried by a packet such as voice data, video data, best efforts data, or background data. Packet properties may include packet source and destination addresses, packet size and type of packet formatting. In one or more embodiments, each packet property is assigned a priority value. In one or more embodiments, the packet or a group of packets may include a packet priority. A packet priority is a priority assigned to a packet based on packet properties. Any mechanism may be used to transmit packets without departing from the scope of the claims. For example, a packet carrying voice data may have a higher priority value than the priority value of a packet carrying background data.

In one or more embodiments, an AP priority is a priority assigned to each AP. In an example, the AP priority defines the rank of an AP with respect to other APs when requesting access to transmit packets. The AP priority defines an importance of an AP transmitting packets as compared to other APs transmitting packets.

In one or more embodiments, the AP priority may be an independently defined value on a scale. For example, each AP may be assigned a value from one to ten irrespective of the value assigned to other APs. In one or more embodiments, the AP priority may be a relative ranked value of the AP with respect to other APs. In other words, the APs may be ordered and a value assigned to the AP that defines the position of the AP with respect to the order. For example, APs in a conference room may be assigned a higher AP priority value than APs in individual offices. In one or more embodiments, the AP priority is globally defined. In other words, the AP priority is defined independently of the use of the AP. Thus, the AP priority may not necessarily depend on the number of active client devices, type of active client devices, or type of data the AP is carrying. The AP priority may be independently defined on a scale with respect to other APs or may be defined relative to other shared devices.

In an embodiment, an AP priority, that is to be used by an AP to determine transmission parameters for transmitting a set of packets, is determined independently of the properties of the set of packets. In an example, the AP priority for the AP may be determined before the set of packets (or properties of the set of packets) is received by the AP.

In one or more embodiments, transmission parameters (not shown) are a set of parameters that define the transmission of packets by an AP. The transmission parameters may include one or more Enhanced Distributed Channel Access (EDCA) parameters. In an example, transmission parameters may specify a contention window. A contention window is a range of time that an AP may retransmit a packet upon failure of a previous packet transmission. In one or more embodiments, the transmission parameters may specify a minimum and maximum time for the contention window. The minimum time is the minimum amount of time the AP is required to wait before packet retransmission. The maximum time is the maximum amount of time the AP may wait before packet retransmission. Alternatively or additionally, the minimum and maximum times may be lower in numerical value for higher priority values in comparison to the minimum and maximum times for lower priority values.

In one or more embodiments, the transmission parameters are calculated based on a combination of (a) AP priority and (b) packet properties. The transmission parameters may also include a width for a radio frequency channel used for communication by APs. Alternatively or additionally, the transmission parameters may include airtime on a shared resource such as bandwidth. Further, the transmission parameters may include the length of a transmission queue. A transmission queue is a queue that includes packets that are ready to be transmitted.

One or more of the APs may include a data repository (e.g., data repository X (112X), data repository Y (112Y)). In one or more embodiments, the data repository (e.g., data repository X (112X), data repository Y (112Y)) is any type of storage unit and/or device (e.g., a file system, database, collection of tables, or any other storage mechanism) for storing data. Further, the data repository (e.g., data repository X (112X), data repository Y (112Y)) may include multiple different storage units and/or devices. The multiple different storage units and/or devices may or may not be of the same type or located at the same physical site.

The data repository (e.g., data repository X (112X), data repository Y (112Y)) includes functionality to store AP properties (e.g., AP X properties (114X), AP Y properties (114Y)) in the system. Any mechanism may be used to store AP properties without departing from the scope of the claims.

In one or more embodiments, an AP property (e.g., AP X properties (114X), AP Y properties (114Y)) is a property of an AP. In particular, an AP property may be stored as a file, a database record, an entry or row in a table, or another data structure. For example, an AP property (e.g., AP X properties (114X), AP Y properties (114Y)) may be the type of AP, the physical location of the AP, transmission parameters, the type of data the AP has historically carried, the type of client devices, or the number of active client devices.

Continuing with FIG. 3A, the data repository may be connected to a priority calculation module (e.g., priority calculation module X (118X), priority calculation module Y (118Y)). In one or more embodiments, a priority calculation module (e.g., priority calculation module X (118X), priority calculation module Y (118Y)) is hardware, software, firmware, or a combination thereof that includes functionality to calculate AP priorities and transmission parameters. In one or more embodiments, the priority calculation module may include functionality to obtain AP properties, calculate AP priority using AP properties, and calculate transmission parameters based on the AP properties.

Continuing with FIG. 3A, the APs may include a priority transmission engine (e.g., priority transmission engine X (116X), priority transmission engine Y (116Y)). In one or more embodiments, a priority transmission engine (e.g., priority transmission engine X (116X), priority transmission engine Y (116Y)) is hardware, software, firmware, or a combination thereof that includes functionality to transmit messages between APs. As shown in FIG. 3A, the priority transmission engine includes wireless distribution logic (270) and wired distribution logic (290) to transmit and receive messages between APs. Each component is described above in FIG. 2. In one or more embodiments, a message is formatted data that includes AP information to calculate or modify AP priority values. In one or more embodiments, the priority transmission engine may include functionality to obtain AP properties and AP priority values, format the AP priority values and other information into messages, and transmit messages to other APs within radio frequency range.

Continuing with FIG. 3A, the APs (e.g., AP X (102X), AP Y (102Y)) may be operatively connected, continuously or intermittently, directly or via the network, to a controller (108). A controller (108) is a digital hardware device that manages the sharing and storage of state information among the networked APs. The controller (108) may include functionality to calculate AP priority values, store AP properties, and regulate use of a shared resource by an AP. The controller (108) may correspond to a computing system or execute on a computing system and cause the computing system to manage state information of APs (e.g., AP X (102X), AP Y (102Y)).

The computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments. For example, the computing system may include one or more computer processor(s), associated memory (e.g., random access memory (RAM), cache memory, flash memory, etc.), one or more storage device(s) (e.g., a hard disk, an optical drive such as a compact disk (CD) drive or digital versatile disk (DVD) drive, a flash memory stick, etc.), and numerous other elements and functionalities. The computer processor(s) may be an integrated circuit for processing instructions. For example, the computer processor(s) may be one or more cores, or micro-cores of a processor. The computing system may also include one or more input device(s), such as a touchscreen, keyboard, mouse, microphone, touchpad, electronic pen, or any other type of input device. Further, the computing system may include one or more output device(s), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system may be connected to a network (106) (e.g., a local area network (LAN), a wide area network (WAN) such as the Internet, mobile network, or any other type of network) via a network interface connection (not shown). The input and output device(s) may be locally or remotely (e.g., via the network) connected to the computer processor(s), memory, and storage device(s). Many different types of computing systems exist, and the aforementioned input and output device(s) may take other forms. Further, one or more elements of the aforementioned computing system may be located at a remote location and connected to the other elements over a network.

Although not shown in FIG. 3A, software instructions in the form of computer readable program code to perform embodiments may be stored, in whole or in part, temporarily or permanently, on a non-transitory computer readable medium, such as a CD, DVD, storage device, a diskette, a tape, flash memory, physical memory, or any other computer readable storage medium. Specifically, the software instructions may correspond to computer readable program code that when executed by a processor(s), is configured to perform embodiments. The aforementioned software instructions may be or may implement all or a part of the AP (e.g., AP X (102X), AP Y (102Y)), the priority transmission engine (e.g., priority transmission engine X (116X), priority transmission engine Y (116Y)), the priority calculation module (e.g., priority calculation module X (118X), priority calculation module Y (118Y)), the data repository (e.g., data repository (112X), data repository Y (112Y)), and/or another component.

While FIG. 3A shows a configuration of components, other configurations may be used without departing from the scope of the claims. For example, various components may be combined to create a single component. As another example, the functionality performed by a single component may be performed by two or more components.

FIG. 3B shows an alternate configuration of a system in accordance with one or more embodiments. As shown in FIG. 3B, the system includes devices (e.g., device Q (101Q), device R (101R), device S (101S), device T (101T)), APs (e.g., AP X (102X), AP Y (102Y)), a network (106), and a controller (108). The devices (e.g., device Q (101Q), device R (101R), device S (101S), device T (101T)), APs (e.g., AP X (102X), AP Y (102Y)), the network (106), and the controller (108) in FIG. 3B may be the same or similar to the devices, APs, the network, and the controller in FIG. 3A.

In one or more embodiments, the controller (108), as shown in FIG. 3B, may include a data repository (112), priority calculation module (121), and priority transmission engine (116). The data repository (112) may include the AP properties ((e.g., AP properties X (114X), AP Y (114Y)).

As shown in FIG. 3B, the controller may include a priority calculation module (121) to calculate AP priority values for each AP connected to the network. Similarly, the controller may also include a priority transmission engine (116) to transmit messages to each AP that include the AP priority values. In other words, the controller may include functionality to perform all or a portion of the calculation of the AP priority values and/or transmission parameters that is AP is configured to perform in FIG. 3A. The controller may be configured to perform the functionality of the calculations in addition to or instead of the AP being configured to perform the functionality.

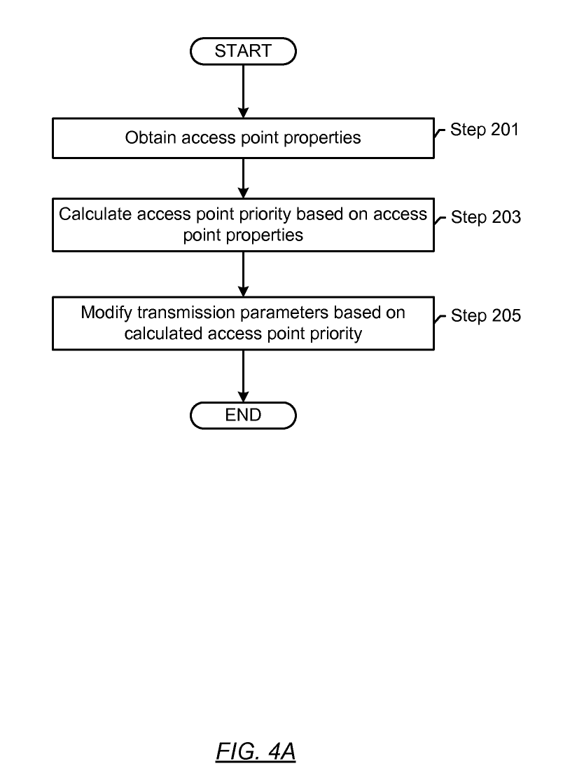

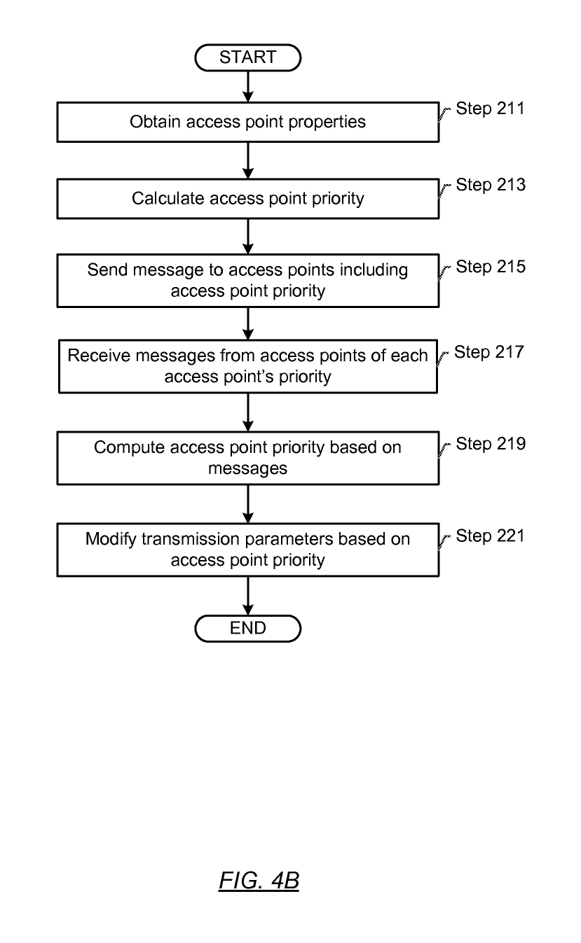

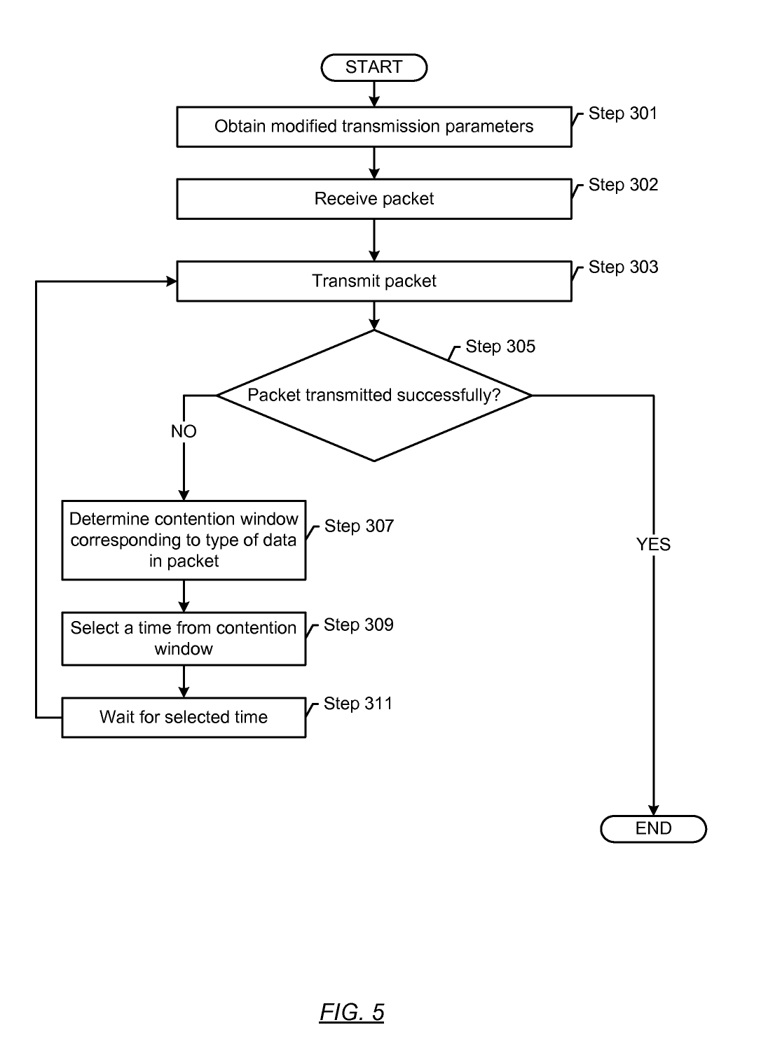

FIGS. 4A, 4B, and 5 show flowcharts in accordance with one or more embodiments. While the various steps in these flowcharts are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments. By way of an example, determination steps may not require a processor to process an instruction unless an interrupt is received to signify that condition exists in accordance with one or more embodiments. As another example, determination steps may be performed by performing a test, such as checking a data value to test whether the value is consistent with the tested condition in accordance with one or more embodiments.

Turning to FIG. 4A, FIG. 4A shows a flowchart for calculating AP priority values in accordance with one or more embodiments. In Step 201, the AP properties are obtained in accordance with one or more embodiments. Specifically, the AP properties used in the calculation of AP priority values are obtained. In one or more embodiments, the AP properties are obtained from a data repository of an AP. Alternatively or additionally, the AP properties may be obtained from a data repository of a controller. The AP properties may be obtained via a network or direct wired/wireless connections. For example, the physical location of the AP, the type of AP, and the type of data historically carried by the AP may be obtained.

In Step 203, the AP priority is calculated in accordance with one or more embodiments. Specifically, a predetermined formula calculates an AP priority value using AP properties. In one or more embodiments, each AP property obtained in Step 201 is assigned a weight and an AP priority value is calculated as described below. A weight defines an importance of a property with respect to other properties using a predetermined range of values. For example, each AP property type may be assigned a value from 0 to 1 that defines the weight of the AP property as compared to other AP properties. In the example, the type of AP may be assigned a weight of 0.8 while the type of packets historically carried by the AP is assigned a weight of 0.2, giving the AP property of type of AP a relative higher importance than the AP property of type of packets historically carried by the AP.

In one or more embodiments of the invention, each AP property has a scaled score. The scaled score is the value of the AP property for a specific AP. In one or more embodiments, a scaled score is a value representing the degree to which a property is satisfied on a particular AP. The scaled score may be calculated by obtaining a raw value for the property and calculating the scaled score using a predefined formula and raw value or querying a table with the raw value for the scaled score. For example, using a scale of 1 to 10 with 10 as the highest degree and 1 as the lowest degree, an AP may have 50 users connected, which is relatively low compared to the other APs. In the example, the number of client devices connected for the particular AP is assigned a scaled score of 5 for the AP property of number of devices connected.

Different mechanisms may be used to obtain a AP priority value from the scaled score and the weights. For example, the AP priority value may then be calculated as a weighted average. A weighted average is the sum of weights multiplied with corresponding scaled scores of properties. In one or more embodiments, the weighted average is calculated using the following formula:

Weighted average=Σwᵢ*sᵢ,

where wᵢ is the weight of AP propertyᵢ and sᵢ is the scaled score of AP propertyᵢ.

As discussed above, AP properties affect the calculation of an AP priority value. The following are some examples describing how different AP properties may affect the AP priority value.

In one or more embodiments, the AP priority is calculated based on the type of AP (e.g., configuration of AP, manufacturer and/or model number of AP, relative or absolute performance of the AP, or other such type information). Specifically, the AP property of AP type may weighted as discussed above. For example, if the type of AP is defined as relative performance, a high performance APs may have a greater scaled score value than a low performance AP thereby similarly affecting the resulting AP priority values.

Alternatively or additionally, the AP priority is calculated based on the physical location of the AP. Specifically, the AP property of AP physical proximity to a location is assigned a value on the scaled score. In one or more embodiments, the AP priority is calculated based on the physical location of an AP in relation to other APs. For example, an AP located in a CEO's office may include a higher scaled score compared to the scaled score of an AP located in a cafeteria thereby similarly affecting the resulting AP priority values.

As another example, the AP priority of an AP may be calculated based on the data historically carried by the AP in accordance with one or more embodiments. Specifically, the AP property of data transmitted by an AP is assigned a scaled score. For example, if the last 1,000 packets transmitted by an AP were voice data, the AP may have a higher AP scaled score compared to an AP that historically transmits background data.

Alternatively or additionally, the AP priority value may be based on the length of a transmission queue. Specifically, the length of the queue of packets ready for transmission may be assigned a scaled score. For example, if longer transmission queues are given higher scaled scores, an AP with a transmission queue of packets that is twice as large as the transmission queue of any other AP connected to the network is assigned a higher scaled score compared to the remaining APs.

In one or more embodiments, the AP priority is calculated based on the AP property of a predetermined schedule. Specifically, the AP priority is dynamically calculated based on a predetermined timing schedule. For example, if an AP is in a conference room and a meeting is scheduled from 2 to 3 pm, the AP may have both the highest scaled score during the time of the meeting than when no meetings exist or than other APs. This timing schedule can be accessed by the nearby APs via an Exchange calendar lookup by the AP with a known position.

In addition to the examples above, the AP priority may be calculated based on packet properties of a packet or group of packets in accordance with one or more embodiments. Specifically, one or more packet properties may be weighted and assigned a scaled score. In one or more embodiments, the packet properties are used in combination with AP properties to calculate AP priority values. For example, the size of a packet may be assigned a scaled score that is used in a weighted average.

The various examples above show how different AP properties and packet properties may be assigned a scaled score and ultimately used to obtain an AP priority. One or more of the AP properties and packet properties, and, optionally, additional properties, may be assigned a weight, and used to calculate the AP priority value. The weights may or may not be equal for multiple AP properties. For example, the physical location property may be assigned a weight of 0.4 and the transmission queue property may be assigned a weight of 0.6. The scaled scores for each AP of the two AP properties may be multiplied by the respective weights to obtain the AP priority value for each AP. The above are only a few examples. Alternative or additional properties may be used without departing from the scope of the invention.

In one or more embodiments, the AP priority is calculated dynamically. In other words, the AP priority values may be modified as the AP properties change. In one or more embodiments, the AP priority values are recalculated after each client device association or dissociation. Further, the AP priority values may be recalculated on a periodic basis. For example, if, after an initial calculation of the AP priority, a determination is made that location of the AP is the most important AP property, the weight of an the AP property may be increased thereby changing the AP priority after the initial calculation. As another example, the scaled score of the access point property, such as the number of client devices connected to an AP, may change and accordingly affect the scaled score and thus dynamically affect the AP priority. In other words, both the weight and scaled score may dynamically affect the AP priority value after the initial calculation to obtain a new AP priority value.

In one or more embodiments, the AP priority may be calculated based on the number of client devices currently connected to the AP. Further, the AP priority may be calculated when no client devices are currently connected to the AP. Further, the AP priority may be based on the number of active voice and/or video calls. For example, if the AP priority was initially calculated when no client devices were connected to the AP, the AP priority may be recalculated as client devices connect to the AP. In the example, the scaled score of the number of client devices connected to the AP may increase as more devices connect to the AP. Alternatively or additionally, the AP priority is also based on the type of client devices currently associated with the AP. In other words, regardless of whether a client device is currently connected to the AP, the type of client devices generally associated with the AP may affect AP priority. By way of an example, if an AP is associated with 200 mobile devices, the AP priority is calculated using the priority level assigned to mobile devices, regardless of the number of mobile devices currently connected to the AP.

In one or more embodiments, the AP priority for each AP is calculated independently. In other words, the AP priority value is calculated without regard to the AP priority values of other APs. Alternatively or additionally, the AP priority value is calculated without regard to packet properties. Specifically, the AP priority is determined regardless of the particular packet being transmitted.

In Step 205, the transmission parameters of an AP are modified based on the calculated AP priority in accordance with one or more embodiments. Specifically, given the AP priority value, the transmission parameters of an AP are adjusted accordingly. In one or more embodiments, the transmission parameters are determined without regard to the type of data the packet is carrying.

In one or more embodiments, one type of transmission parameter is the contention window for retransmitting packets. For example, the transmission parameters for a lower AP priority value may widen the contention window to retransmit a packet while the transmission parameters for a higher AP priority value may narrow the contention window to retransmit the packet. In the example, the minimum time for APs with a higher AP priority value may be lower than the minimum time for APs with a lower AP priority value, thereby increasing the probability of the packet being retransmitted faster for the AP with the higher priority value.

By way of another example, the values of both the minimum and maximum times of contention windows for higher priority APs may be lowered in numerical value than for lower priority APs, decreasing the wait time for a packet to be retransmitted. Thus, in the case of a failed packet transmission of an AP with a high AP priority value, the AP selects a random time from the narrowed range contention window and waits before the packet is re-transmitted, increasing the probability of the packet being retransmitted faster compared to if the packet were on other APs.

In one or more embodiments of the invention, each AP may have multiple contention windows, whereby each contention window is for a different type of packet payload. For example, one contention window may be for packets that have background data, another for packets that have a payload to be transmitted with best efforts, another for packets that have video data, and another for packets that have voice data. Each of the contention windows may be a subdivision of a master contention window for the type of payload, such than an AP uses the contention window corresponding to the priority value of the AP.

For example, if all APs retransmit packets having a payload of voice data between three to seven milliseconds (i.e., the master contention window is three to seven milliseconds), the AP with the highest AP priority value may have a contention window as three to five milliseconds, the AP with the medium AP priority value may have a contention window of four to six milliseconds, and the AP with the lowest AP priority value may have a contention window of five to seven milliseconds for packets having payloads of voice data. Thus, for voice data, the AP with the highest AP priority value is more likely to retransmit faster than the AP with the medium AP priority value and will retransmit faster than the AP with the lowest AP priority value.

By way of another example, if all APs retransmit packets having a payload of video data between seven to fifteen milliseconds (i.e., the master contention window is seven to fifteen milliseconds), the AP with the highest AP priority value may have a contention window as seven to ten milliseconds, the AP with the medium AP priority value may have a contention window of nine to thirteen milliseconds, and the AP with the lowest AP priority value may have a contention window of twelve to fifteen milliseconds for packets having payloads of video data. Thus, for video data, the AP with the highest AP priority value is more likely to retransmit faster than the AP with the medium AP priority value and will retransmit faster than the AP with the lowest AP priority value.

In one or more embodiments, the transmission parameters may be a shared connection resource. Specifically, the use of a shared connection resource by APs may be regulated using the AP priority values. A shared connection resource is a resource of the network, such as bandwidth, that connects the AP to the network. For example, the percentage of the shared connection resource that is allocated to a particular AP may be calculated by the following formula:

Percentage allocated=(AP priority value*100)/(sum of AP priority values).

In one or more embodiments, the transmission parameter may be the length of a transmission queue. Specifically, the transmission queue length may be decreased or increased based on an AP priority value. For example, if an AP is calculated to have a high AP priority value, then the transmission queue length of the AP may be increased, allowing more use of the shared connection resources by the AP. In the example, the transmission queue lengths of the remaining APs may be decreased, lowering the number of packets that may be ready for transmittal.

Instead of calculating AP priority as shown in FIG. 4A, some systems use messages to send each AP the AP priority of other APs. Namely, the AP priority is calculated relative to the priority of other APs.

Turning to FIG. 4B, FIG. 4B shows an alternate flowchart for calculating AP priority using messages in accordance with one or more embodiments. In Step 211, AP properties are obtained in accordance with one or more embodiments. The step is the same or similar to Step 201 of FIG. 4A.

In Step 213, AP priority is calculated in accordance with one or more embodiments. The step is the same or similar to Step 203 of FIG. 4A.

In Step 215, a message including AP priority is sent to APs in accordance with one or more embodiments. Specifically, a message is sent, to each AP in group of APs, including the AP priority of an AP. The group of APs may be the APs within radiofrequency range of each other, APs connected to the same controller, APs in the same geographic region (e.g., same building, same campus, etc.), or any collection of APs that may have conflicts in transmission. In one or more embodiments, the controller sends messages to each AP, where the message includes the AP priority of APs within radio frequency range.

In Step 217, messages including AP priority of every AP are received in accordance with one or more embodiments. Specifically, the messages received include the AP priority of APs within radio frequency range. For example, the messages may include the AP priority values, calculated on a numeric scale, of every AP within radio frequency range.

In Step 219, the AP priority is computed based on the received messages in accordance with one or more embodiments. Specifically, with the AP priority of each AP known, the AP priority is recalculated. In one or more embodiments, the AP priority value is recalculated by ordering the AP priority values of the other APs and recalculating priority values. Specifically, the weights and scaled scores of AP properties may be reassigned based on importance of a property and the degree to which the property is satisfied. In one or more embodiments, the AP priority values may be recalculated using the formula in Step 213. In other words, the AP properties may be checked for any changes and the AP priority values may be recalculated accordingly. For example, on a scale of 1 to 10 with 1 being the highest priority, three APs have AP priority values of (i) 3, (ii) 7, and (iii) 5. In the example, after messages are received, the AP priority values are ordered and reassigned priorities. Thus, the AP priority values are reassigned: (i) 1, (ii) 3, and (iii) 2, respectively.

In Step 221, the transmission parameters are modified based on the AP priority in accordance with one or more embodiments. The step is the same or similar to Step 205 of FIG. 4A.

Turning to FIG. 5, FIG. 5 shows a flowchart for transmitting packets using AP priority in accordance with one or more embodiments. In Step 301, modified transmission parameters are obtained in accordance with one or more embodiments. In one or more embodiments of the invention, the modified transmission parameters may be obtained using FIGS. 4A and/or 4B. In Step 302, a packet is received in accordance with one or more embodiments. In one or more embodiments, a device connected to the AP sends a packet to the AP. Alternatively, the packet may be received from the network by the AP. In Step 303, the packet is transmitted in accordance with one or more embodiments. In one or more embodiments, the packet is transmitted on the network or to a device connected to the AP.

In Step 305, a determination is made whether the packet is transmitted successfully in accordance with one or more embodiments. The determination whether the packet is transmitted successfully may be based on whether the packet collided with another packet upon transmittal in Step 303. Two packets collide when both packets are transmitted at the same time, causing neither packet to be successfully transmitted. If the determination is made that the packet was transmitted, then the process ends. Otherwise, the process proceeds to Step 307.

In Step 307, the contention window corresponding to a packet property of the packet is determined in accordance with one or more embodiments. Specifically, the packet property in the packet is identified and the contention window, which is specified by modified transmission parameters, is selected based on the packet property. As discussed above, the transmission parameters are calculated based on the AP priority, and the transmission parameters affect the contention window. Thus, in one or more embodiments, the contention window that is selected based on corresponding to the packet property reflects the AP priority.

For example, consider the scenario in which the packet property is the type of payload in the packet. In such an example, the type of payload in the packet is identified, such as from the header of the packet or other identifier, and used to select the contention window. In the example, if voice data is designated to have a higher priority level compared to background data, then the contention window for the packets including voice data may have less minimum and/or maximum times than the contention window for packets including background data. Accordingly, packets that are identified as having voice data are retransmitted faster than packets that are identified has having background data. In both cases, however, the AP priority also affects the retransmission rate as the AP priority affects the contention window.

Alternatively or additionally, in some embodiments, the AP priority is modified based on the type of payload in the packet. Specifically, the AP priority is dynamically calculated to include the type of payload in the packet in the calculation of AP priority and the transmission parameters are recalculated to reflect the dynamically calculated AP priority.

In Step 309, a time is selected from the contention window in accordance with one or more embodiments. Specifically, a random time is selected from the contention window. Any mechanism may be used to select a random time without departing from the scope of the claims. In Step 311, the packet waits for the selected time before being retransmitted in accordance with one or more embodiments. Specifically, the re-transmittal of the packet is delayed by the selected time in order to avoid another packet collision. For example, when a random time is selected from a narrow contention window with lower numerical minimum and maximum time values, the re-transmittal of the packet is more likely to be less delayed than a random time selected from a wide contention window with higher numerical minimum and maximum time values. After waiting for the selected time, the packet is transmitted in Step 303.

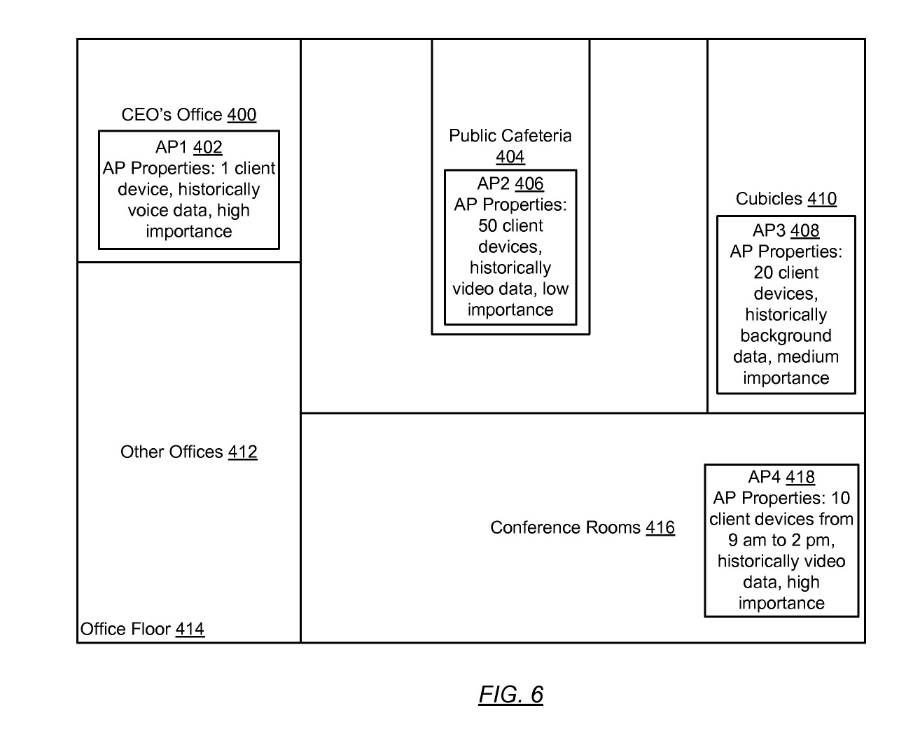

The following example is for explanatory purposes only and not intended to limit the scope of the claims. In the following example, consider the scenario in which a business is hosting a meeting on the floor of an office as shown in FIG. 6. Each user with a client device connects to the physically closest AP. Also shown in FIG. 6, each AP has the corresponding AP properties including the number of client devices currently connected, the data historically carried by packets transmitted by an AP, and the levels of importance based on physical location. For example, AP1 (402) is located in the CEO's office (400) and thus has a high importance. As a predetermined setting, the type of data carried by a packet is prioritized from least important to most important: background data, video data, and voice data. Further, the level of importance based on physical location is prioritized from least important to most important: public cafeteria (404), cubicles (410), other offices (412), conference rooms (416), and the CEO's office (400).

Continuing with the example, the weights on each access priority are as follows: (1) number of client devices currently connected has a weight of 20%, (2) data historically carried by packets transmitted by an AP has a weight of 30%; and (3) levels of importance based on physical location has a weight of 50%.

Continuing with the example, the priority of each AP is determined for packet transmittal. Using the properties of each AP as explained above, the AP priority is first determined at each AP. Each AP property is first assigned a value on a scale of 1 to 10 (with 10 being the highest priority) and then each AP property value is multiplied by the respective weight. The sum of the weighted AP property values determines the initial AP priority. The formula for calculating AP priority values is as follows:

AP priority value=(scaled score of number of client devices currently connected*0.2)+(scaled score of data historically carried by packets*0.3)+(scaled score of level of importance based on physical location*0.5).

Continuing with the example, for AP1 (402), based on the fact that one client device is connected, the number of client devices is scaled for a score of 1. The voice data historically carried by packets is scaled for a score of 8. Based on the fact that the AP is located in the CEO's office (400), the level of importance based on physical location is scaled for a score of 10. When multiplied with the respective weights and summed, the AP priority is 7.6 for AP1, as shown below:

AP priority value=(1*0.2)+(scaled 8*0.3)+(10*0.5)=7.6.

Continuing with the example, for AP2 (406), based on the fact that 50 client devices are connected, the number of client devices is scaled for a score of 8. The video data historically carried by packets is scaled for a score of 8. Based on the fact that the AP is located in the public cafeteria (404), the level of importance based on physical location is scaled for a score of 1. When multiplied with the respective weights and summed, the AP priority is 4.5 for AP2, as shown below:

AP priority value=(8*0.2)+(8*0.3)+(1*0.5)=4.5.

Continuing with the example, for AP3 (408), based on the fact that 20 client devices are connected, the number of client devices is scaled for a score of 4. The background data historically carried by packets is scaled for a score of 1. Based on the fact that the AP is located in the cubicles (404), the level of importance based on physical location is scaled for a score of 5. When multiplied with the respective weights and summed, the AP priority is 3.6 for AP3, as shown below:

AP priority value=(4*0.2)+(1*0.3)+(5*0.5)=3.6.

Continuing with the example, for AP4 (418), based on the fact that 10 client devices are connected, the number of client devices is scaled for a score of 2. The video data historically carried by packets is scaled for a score of 8. Based on the fact that the AP is located in the conference rooms (404), the level of importance based on physical location is scaled for a score of 10. When multiplied with the respective weights and summed, the AP priority is 7.8 for AP4, as shown below:

AP priority value=(2*0.2)+(8*0.3)+(10*0.5)=7.8.

Continuing with the example, after each AP calculates the AP priority value, each AP sends a message to the other APs. The message includes the AP priority value of the AP sending the message. In the example, AP1 (402) sends a message including the AP priority value of 7.6 to AP2 (406), AP3 (408), and AP4 (418). Likewise, AP2 (406), AP3 (408), and AP4 (418) send messages to each other and AP1 (402) with the respective AP priority values. The messages sent by AP4 (418) also includes that the priority value is valid from 9 am to 2 pm. Before or after that time, the AP priority value may be recalculated.

When AP1 (402) receives the messages including the AP priority values of AP2 (406), AP3 (408), and AP4 (418), AP1 (402) may recalculate the AP priority values. Specifically, AP1 (402) may order the APs based on AP priority values and reassign priorities. In the example, the APs are ordered from 1 to 4, with 4 being the highest priority. After ordering the APs using priority values from above, AP1 (402) determines the following order of APs: (i) AP1 (402) is reassigned to an AP priority value of 3; (ii) AP2 (406) is reassigned to an AP priority value of 2; (iii) AP3 (408) is reassigned to an AP priority value of 1; and (iv) AP4 (418) is reassigned to an AP priority value of 4. Similarly, AP2 (406), AP3 (408), and AP4 (418) order and reassign priorities as shown above.

Based on the reassigned AP priorities, the transmission parameters are modified. Specifically, the bandwidth of the network is divided among the APs using a formula:

(AP priority of selected AP*100)/(sum of AP priority values).

For each AP, the allocation of bandwidth based on the reassigned AP priority values is as follows:

AP1(402):(3*100)/(1+2+3+4)=30%

AP2(406):(2*100)/(1+2+3+4)=20%

AP3(408):(1*100)/(1+2+3+4)=10%

AP4(418):(4*100)/(1+2+3+4)=40%.

When each AP transmits a packet, the percentage of bandwidth allocated to the given AP will be considered.

Further, the contention window for each AP is modified based on the reassigned AP priority values. Specifically, the contention window may be split into smaller ranges, where each smaller range corresponds to an AP. In the example, each AP starts out with a contention window of a minimum wait time of 3 nanoseconds and a maximum wait time of 22 nanoseconds, regardless of the type of data. Using the reassigned AP priority values, the contention window time may be split into 4 smaller ranges such as:
Contention Window 1A: 3-7 nanoseconds
Contention Window 2A: 8-12 nanoseconds
Contention Window 3A: 13-17 nanoseconds
Contention Window 4A: 18-22 nanoseconds

Based on the priorities above, the APs are reassigned contention window times: (i) AP1 (402) is reassigned to contention window 2A; (ii) AP2 (406) is reassigned to contention window 3A; (iii) AP3 (408) is reassigned to contention window 4A; and (iv) AP4 (418) is reassigned to contention window 1A. Accordingly, AP4 (418), the AP with the highest priority, has a contention window with the lowest numerical wait times for packet re-transmittal. The other APs are assigned new contention window times based on priority as well. Thus, packets from the higher priority AP will be re-transmitted faster than packets from lower priority APs.

Alternatively or additionally, the transmission queue length may be modified based on the reassigned AP priority values. For example, the transmission queue length may be increased for AP4 (418) as the highest priority AP, allowing more packets to be ready for transmittal.

In one or more embodiments, the AP priority values are calculated using a controller. Further, the controller sends messages to APs with the re-calculated AP priorities as shown above. The controller may also send the modified transmission parameters to each AP.

While embodiments have been described with respect to a limited number of embodiments, those skilled in the art, having benefit of this disclosure, will appreciate that other embodiments can be devised which do not depart from the scope of the claims as disclosed herein. Accordingly, the scope of the claims should be limited only by the attached claims.

1. A non-transitory computer readable medium (CRM) comprising instructions which, when executed by one or more hardware processors, causes performance of operations comprising:
determining a priority level for an Access Point (AP); and
subsequent to determining the priority level for the AP:
receiving, by the AP, a plurality of packets,
determining one or more transmission parameters for transmitting the plurality of packets based at least in part on the priority level of the AP, and
transmitting, by the AP, the plurality of packets using the one or more transmission parameters that were determined based at least in part on the priority level of the AP.

2. The CRM of claim 1, wherein the priority level of the AP is determined independently of a priority level associated with the plurality of packets.

3. The CRM of claim 1, wherein the priority level of the AP is determined based on a type of the AP.

4. The CRM of claim 1, wherein the priority level of the AP is determined based on a physical location of the AP.

5. The CRM of claim 1, wherein the priority level of the AP is determined based on characteristics of data historically transmitted by the AP.

6. The CRM of claim 1, wherein the one or more transmission parameters for the AP are further based on a second priority level of a second AP within a radio frequency range of said AP.

7. The CRM of claim 1, wherein the priority level of the AP is dynamically determined.

8. The CRM of claim 1, wherein the priority level of the AP is based on a number of client devices currently connected to the AP.

9. The CRM of claim 1, wherein the priority level of the AP is based on a type of client devices currently associated with the AP.

10. The CRM of claim 1, wherein the priority level of the AP is based on a number of active voice calls and/or a number of active video calls for clients connected to the AP.

11. The CRM of claim 1, wherein the priority level of the AP is dynamically determined based on a schedule.

12. The CRM of claim 1, wherein the transmission parameters comprise one or more Enhanced Distributed Channel Access (EDCA) parameters.

13. The CRM of claim 1, wherein the operations further comprise:
allocating airtime to a plurality of APs based on a corresponding priority level of each of the plurality of APs.

14. The CRM of claim 1, wherein the transmission parameters include a width for a radio frequency channel used for communication by the AP.

15. The CRM of claim 1, wherein the priority level for the AP is determined by a controller.

16. The CRM of claim 1, wherein the priority level for the AP is determined when no client devices are connected to the AP.

17. The CRM of claim 1, wherein a priority level for the AP is determined based on a relative priority of the AP compared to another AP.

18. The CRM of claim 1, wherein the priority level for the AP is determined based on a length of a transmission queue.

19. A system comprising:
at least one device including a hardware processor;
the system being configured to perform operations comprising:
determining a priority level for an access point (AP), and
subsequent to determining the priority level for the AP:
receiving, by the AP, a plurality of packets,
determining one or more transmission parameters for transmitting the plurality of packets based at least in part on the priority level of the AP, and
transmitting, by the AP, the plurality of packets using the one or more transmission parameters that were determined based at least in part on the priority level of the AP.

20. A method comprising:
determining a priority level for an access point (AP); and
subsequent to determining the priority level for the AP:
receiving, by the AP, a plurality of packets,
determining one or more transmission parameters for transmitting the plurality of packets based at least in part on the priority level of the AP, and
transmitting, by the AP, the plurality of packets using the one or more transmission parameters that were determined based at least in part on the priority level of the AP.

21. The method of claim 20, wherein determining the one or more transmission parameters for transmitting the plurality of packets is further based on a priority associated with each of the plurality of packets.
